(19) United States
(12) Patent Application Publication
(10) Pub. No.: US 2012/0036069 A1
(43) Pub. Date: Feb. 9, 2012

(54) SYSTEM AND METHOD FOR REMOTELY PROVIDING FINANCIAL SERVICES

(75) Inventors: Christopher Filipe Silvestre, Toronto (CA); Paul Jozef Sobocinski, Toronto (CA); George Foncea Antiochou, Toronto (CA)

(73) Assignee: Loans for less Inc., Toronto (CA)

(21) Appl. No.: 12/852,605

(22) Filed: Aug. 9, 2010

(51) Int. Cl. G06Q 40/00

(52) U.S. Cl. 705/42

(57) ABSTRACT

Systems and methods for providing two-way communication between a plurality of remote terminals and at least one operator terminal. The operator terminal displays a session-specific user interface for each remote terminal with which it is in communication. Multiple interfaces are displayed concurrently, so that a human operator using the operator terminal can monitor and manage multiple sessions corresponding to multiple remote terminals. Customers using the remote terminals can enter or otherwise provide data relating to a transaction. The data is transmitted to the operator terminal and displayed in the session-specific user interface corresponding to the remote terminal from which it originates. The operator can review the data and perform actions based on the data.

### FIELD

The embodiments described herein relate to methods and systems for providing two-way communication and in particular to methods and systems for providing two-way communication between a plurality of remote terminals and at least one operator terminal.

### INTRODUCTION

Traditionally, financial services have been provided by financial institutions such as banks and credit unions. In addition to banks and credit unions, there exist a number of alternative financial service providers. Alternative financial service providers may provide services such as short-term loans, check cashing and pre-paid credit cards. Frequently, alternative financial service providers operate from retail establishments located in areas underserviced by traditional financial institutions.

### SUMMARY

In one broad aspect, there is provided a system for providing two-way communication, the system comprising at least one operator terminal comprising an operator display and an operator input device; a plurality of remote terminals, wherein each of the plurality of remote terminals is connectable to the at least one operator terminal for communication therewith, and comprises a remote display and at least one remote input device operable to receive customer transaction data comprising at least one customer request from a customer; a processor connectable to the at least one operator terminal and the plurality of remote terminals for communication therewith; a non-transitory computer-readable storage medium with an executable program stored thereon, the program for instructing the processor to provide a session module for establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal; a data processing module operable to receive, for each transaction session, the customer transaction data relating to the transaction session from the corresponding remote terminal, and generate, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and an interface module operable to, at the specific time, provide a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.

For each transaction session and the corresponding operator session interface, the data processing module may be further operable to receive operator input data from the operator input device identifying one of the plurality of possible request responses.

For each transaction session, the data processing module may be further operable to generate response data based on the operator input data and transmit the response data to the corresponding remote terminal.

The session module may be operable to establish each transaction session in the maximum concurrent number of transaction sessions upon receiving a corresponding session initiation request from the corresponding remote terminal.

For each transaction session, the session module may be further operable to generate a unique identifier for distinguishing that transaction session from all other transaction sessions in the maximum concurrent number of transaction sessions.

For each transaction session in the maximum concurrent number of transaction sessions, the processor may be further operable to generate a unique customer identifier based on the customer transaction data, the unique customer identifier corresponding to the customer using the corresponding remote terminal, generate a customer record corresponding to the unique customer identifier, and store the customer record in a transaction database.

For each transaction session in the maximum concurrent number of transaction sessions, the processor may be further operable to determine a unique customer identifier based on the customer transaction data, the unique customer identifier corresponding to the customer using the corresponding remote terminal, and update a customer record corresponding to the unique customer identifier and stored in a transaction database, the update based on the transaction session.

For each transaction session in the maximum concurrent number of transaction sessions, the processor may be further operable to retrieve, based on the unique customer identifier, the customer record stored in the transaction database and configure the corresponding operator session interface to display information based on the customer record.

The at least one operator terminal may comprise two or more operator terminals, and the session module may establish, at the specific time, up to the maximum concurrent number of transaction sessions with the two or more operator terminals, such that each transaction session involves one and only one corresponding remote terminal and one and only one of the two or more operator terminals.

The session manager may be operable to load balance between the two or more operator terminals when establishing transaction sessions, such that the session manager is operable to establish each transaction session in the maximum concurrent number of transaction sessions based on, for each operator terminal, a number of currently and previously established transaction sessions at that operator terminal.

For each transaction session in the maximum concurrent number of transaction sessions, the corresponding remote terminal may be configurable to interact with the customer in a customer language, and the processor may be operable to translate the customer transaction data that is received in the customer language for presentation in the corresponding operator session interface in an operator language that differs from the customer language.

Each of the plurality of remote terminals may comprise a document imaging device for capturing at least one document image, and the customer transaction data for each remote terminal may comprise the at least one document image.

Each of the plurality of remote terminals may comprise a customer imaging device for capturing at least one image of the customer, and the customer transaction data for each remote terminal may comprise the at least one image.

In another broad aspect, there is provided a method for providing two-way communication, the method comprising connecting at least one operator terminal to a plurality of remote terminals for communication therewith, wherein the at least one operator terminal comprises an operator display and an operator input device, and wherein each of the plurality of remote terminals comprises a remote display and at least one remote input device operable to receive customer transaction data comprising at least one customer request from a customer; establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal; receiving, for each transaction session, the customer transaction data relating to the transaction session from the corresponding remote terminal, and generating, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and providing, at the specific time, a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.

In yet another broad aspect, there is provided a computer program product for use on a computer, the computer program product comprising: a non-transitory recording medium; and means recorded on the non-transitory recording medium for instructing the computer to perform the steps of: connecting at least one operator terminal to a plurality of remote terminals for communication therewith, wherein the at least one operator terminal comprises an operator display and an operator input device, and wherein each of the plurality of remote terminals comprises a remote display and at least one remote input device operable to receive customer transaction data comprising at least one customer request from a customer; establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal; receiving, for each transaction session, the customer transaction data relating to the transaction session from the corresponding remote terminal, and generating, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and providing, at the specific time, a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.

Further aspects and advantages of the embodiments described herein will appear from the following description taken together with the accompanying drawings.

### DRAWINGS

For a better understanding of the various embodiments described herein, and to show more clearly how they may be carried into effect, reference will now be made, by way of example only, to the accompanying drawings which show at least one exemplary embodiment, and in which:

FIG. 1 is a block diagram of an exemplary system for two-way communication;

FIG. 2 is a block diagram of another exemplary system for two-way communication;

FIG. 3 is an exemplary default display for a remote terminal;

FIG. 4 is a flowchart of an exemplary registration method;

FIG. 5 is a flowchart of an exemplary transaction method;

FIG. 6 is an exemplary service screen display for a remote terminal;

FIG. 7 is a process flow diagram for an exemplary operator terminal;

FIG. 8 is a process flow diagram for an exemplary remote terminal;

FIG. 9 is an exemplary operator display; and

FIG. 10 is a block diagram of another exemplary system for two-way communication.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. For example and without limitation, the programmable computers may be a server, network appliance, set-top box, embedded device, computer expansion module, personal computer, laptop, personal data assistant, or mobile device. Program code is applied to input data to perform the functions described herein and generate output information. The output information is applied to one or more output devices, in known fashion. In some embodiments, the communication interface may be a network communication interface. In embodiments where elements of the invention are combined, the communication interface may be a software communication interface, such as those for inter-process communication (IPC). In still other embodiments, there may be a combination of communication interfaces.

Each program is preferably implemented in a high level procedural or object oriented programming and/or scripting language to communicate with a computer system. However, the programs can be implemented in assembly or machine language, if desired. In any case, the language may be a compiled or interpreted language.

The system, processes and methods of the described embodiments are capable of being distributed in a computer program product comprising a non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Attempts at automation of alternative financial services, for example automated kiosk machines, have been made to expand service offerings by providing more points of service. Previous systems have required the use of fully automated kiosk machines, with custom software and hardware dedicated to providing relatively few services, such as check cashing. However, such prior systems have only offered a restricted range of services due to the need for complex automation, and proved to be expensive.

Although it is desirable to provide access to a wide suite of alternative financial services in a fully automated system, each additional service requires expensive software and hardware to provide. Attempting to scale back costs by reducing the suite of services to be offered is a large inconvenience to customers, who must then seek out other locations to obtain the additional alternative financial services.

Additionally, fully automated systems can be inflexible. That is, even if a service is offered, it may not be offered with the same degree of customizability or flexibility as would be available at a retail location of the alternative financial service provider, where the customer would interact with a human representative. For example, prior art fully automated check cashing systems may only be able to accept government or payroll checks because the format of these checks is preprogrammed. Check recognition software in the fully automated systems cannot easily be adapted to accept additional types of checks. Accordingly, a wide variety of other legitimate checks may be rejected, inconveniencing the customer.

Furthermore, a fully automated system that only offers a narrow range of services can be more expensive to operate in practice, because the cost of the system cannot be recouped as easily by, for example, offering more services. Changes to service offerings are difficult to make, requiring expensive software development to implement and reducing the adaptibility of the system.

Fully automated systems may also be unsatisfying for customers who are accustomed to interacting with a human representative. Preprogrammed automated responses, especially when coupled with restricted service offerings, may frustrate customers. Moreover, the lack of human interaction increases the risk of fraud and may therefore require cumbersome authentication processes that are intrusive and deter adoption. For example, some prior art systems require customers to register fingerprints and facial scans, creating a privacy risk and thus deterring many customers from using the service. In some cases, customers must also manually provide a large amount of information with each attempt to use the service, making the experience unpleasant, long and cumbersome. As a result, some systems take even more time to use than conducting business at a retail establishment, virtually eliminating any incentive to use the automated system.

Embodiments provided herein can be operated without biometric data, such as fingerprints or facial scans, while retaining security that can be equivalent or superior to that of retail establishments. Likewise, lengthy data entry by the customer can also be eliminated. Instead, the described embodiments employ a closed loop communication system that is familiar to customers. Additionally, the described embodiments can facilitate the provision of a wide variety of services, while retaining maximum customizability.

An exemplary system provides two-way communication between one or more operator terminals and a plurality of remote terminals. The operator terminals can be desktop or laptop computers, and can have a processor, a display and one or more input devices, such as keyboards, mice, trackpads, and the like. The remote terminals can be, for example, computer-based kiosks, and may have a processor, a display and one or more input devices. Each of the plurality of remote terminals can be connected to the operator terminals via a communications network, such as the Internet or other suitable network.

Each remote terminal can communicate with one operator terminal at a time in a communication session. Conversely, each operator terminal can communicate with one or more remote terminals at a time, with separate communication sessions at the operator terminal for each remote terminal. There may be a maximum number of concurrent sessions at each operator terminal.

For each communication session, there may be a session-specific user interface provided at the operator terminal, to enable an operator to distinguish among the communication sessions. The user interfaces can be displayed together at the same time, allowing the operator to efficiently manage multiple concurrent sessions.

For each communication session, a customer can enter or provide data at the remote terminal, which can be transmitted to the operator terminal and presented to the operator in the session-specific user interface that corresponds to the communication session with the remote terminal. Based on the data supplied by the customer, the system may generate a list of possible responses for the operator to choose from. The human operator can then choose an appropriate response, which can be entered via the session-specific user interface, and communicated to the corresponding remote terminal.

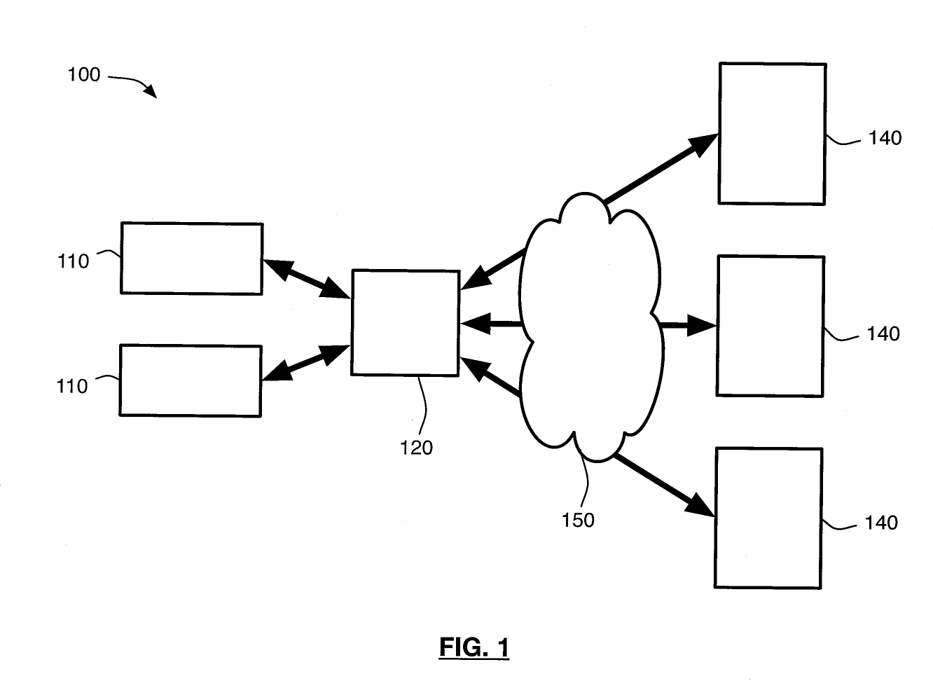

Referring now to FIG. 1, there is illustrated a block diagram of an exemplary two-way communication system 100. Communication system 100 comprises at least one operator terminal 110, a controller 120, a network 150 and a plurality of remote terminals 140.

Each operator terminal 110 can be operatively connected to controller 120 via a data communications link, such as Ethernet, IEEE 802.11 wireless, or any other suitable communications link. Controller 120 can be operatively and securely connected to each remote terminal 140 via data communication links traversing or forming network 150. Network 150 may be a public network, such as the Internet. Alternatively, network 150 may be a private or virtual private network. In some embodiments, network 150 may be a combination of public and private networks. Each data communication link may be encrypted to ensure security and privacy of customer data.

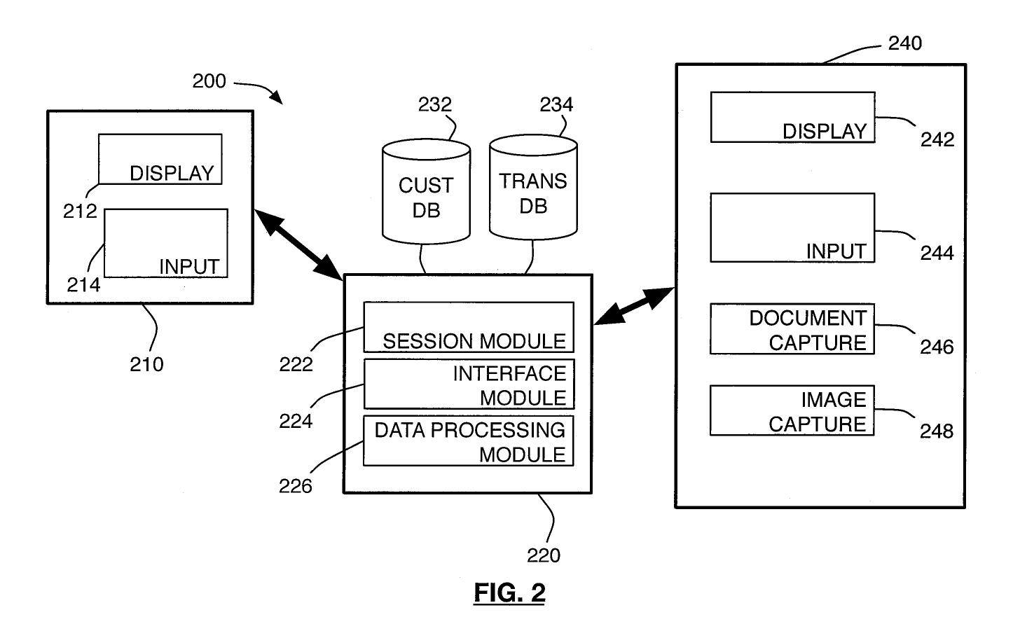

Referring now to FIG. 2, there is illustrated a block diagram of an exemplary two-way communication system 200. Communication system 200 is shown with only one operator terminal 210 and one remote terminal 240 for illustrative purposes; however a plurality of operator terminals 210 and remote terminals 240 may also be provided. A controller 220 can be operatively connected to each of operator terminal 210 and remote terminal 240 via data communication links. Each communication link may traverse a public or private network and be encrypted, as described above in reference to communications system 100.

In an exemplary embodiment, operator terminal 210 comprises a display 212 and an input 214. Display 212 may be one or more physical displays, such as an LCD flat panel. Input 214 may be a keyboard, keypad, mouse, trackpad, near field communication device (e.g., mobile phone), other input device, or some combination thereof. In some embodiments, display 212 may be a touchscreen device, such as a capacitive touchscreen, in which case the functions of display 212 and input 214 may be combined.

In the exemplary embodiment, each operator terminal 212 comprises a touchscreen and two viewing monitors. The touch screen may be configured to allow a human operator to accept information received from a remote terminal, select among error messages for transmission to the remote terminal, search customer or transaction databases, and view customer profiles, previously scanned documents or transaction histories.

In the exemplary embodiment, each remote terminal 240 comprises a display 242 and input 244. Remote terminal 240 may also comprise a document capture device 246 and an image capture device 248. Remote terminal 240 may also be enclosed in a housing (not shown) to form a standalone or embedded kiosk. Each remote terminal 240 or kiosk may be located in remote or convenient locations, such as gas stations, grocery stores, retail shopping centres and the like.

Display 242 may be one or more physical displays, such as an LCD flat panel. Input 244 may be a keyboard, keypad, mouse, trackpad, near field communication device (e.g., mobile phone), other input device, or some combination thereof. In some embodiments, display 242 may be a touchscreen device, such as a capacitive touchscreen, in which case the functions of display 242 and input 244 may be combined.

Document capture device 246 may comprise a general purpose document scanner, suitable for scanning generally flat objects placed on a scanning surface, such as utility bills, driver's licenses, social security cards, passports and the like. The general purpose document scanner may scan in color at a suitable resolution to facilitate a recipient of the scanned image to make a determination as to the authenticity of the scanned document.

In some embodiments, document capture device 246 may comprise more than one device, including one or more of: the general purpose document scanner, a magnetic ink character recognition (MICR) scanner or “check” scanner; a magnetic strip card reader; a smart card or “chip” reader; and the like.

Image capture device 248 may be a video camera or a still camera configured to capture images of a customer currently using the remote terminal. Captured images may be transmitted to the operator terminal to allow the human operator to observe the customer. In embodiments with a video camera, the captured images may form a video sequence. In embodiments with a still camera, the camera may be configured to transmit a series of still images at a predetermined suitable interval.

Controller 220 provides a session module 222, an interface module 224 and a data processing module 226, the operation of which is described herein below. Controller 220 may be operatively connected to one or both of customer database 232 and transaction database 234 for data communication.

Customer database 232 may be a relational database system for storing relevant customer data. Customer data may include biometric data such as identification photos obtained from government issued photographic identification cards and captured by document capture device 246, and images of the customer captured by image capture device 248. Customer data may further include other personal account information, such as name, address, telephone number, account number and the like.

Human operators may be permitted to read customer database 232 as needed to verify authentication and transaction details. However, in some embodiments, human operators may not be permitted to directly alter data in customer database 232. Rather, updates to customer database 232 may be performed by controller 220 in the context of a transaction.

Transaction database 234 may be a relational database system for storing transaction data relating to customer accounts. In operation, transaction database 234 can be used to store records or transaction data relating to each session between a remote terminal and an operator terminal. Subsequently, transaction data may be recalled to verify a new transaction, for auditing purposes, or the like.

Customer data in customer database 232 may be linked to transaction data in transaction database 234 to store customer data to be associated with stored transaction histories. Each of database 232 and 234 may be searchable to locate relevant customer information and transaction histories for each customer.

Customer database 232 and transaction database 234 may be provided by a single relational database system. Alternatively, various elements of each database 232 and 234 may be further subdivided to provide more efficient operation, according to known principles of relational databases.

In operation, remote terminal 240 may be configured to authenticate known or returning customers. In some embodiments, remote terminal 240 may also be configured to allow new customers to register a new account.

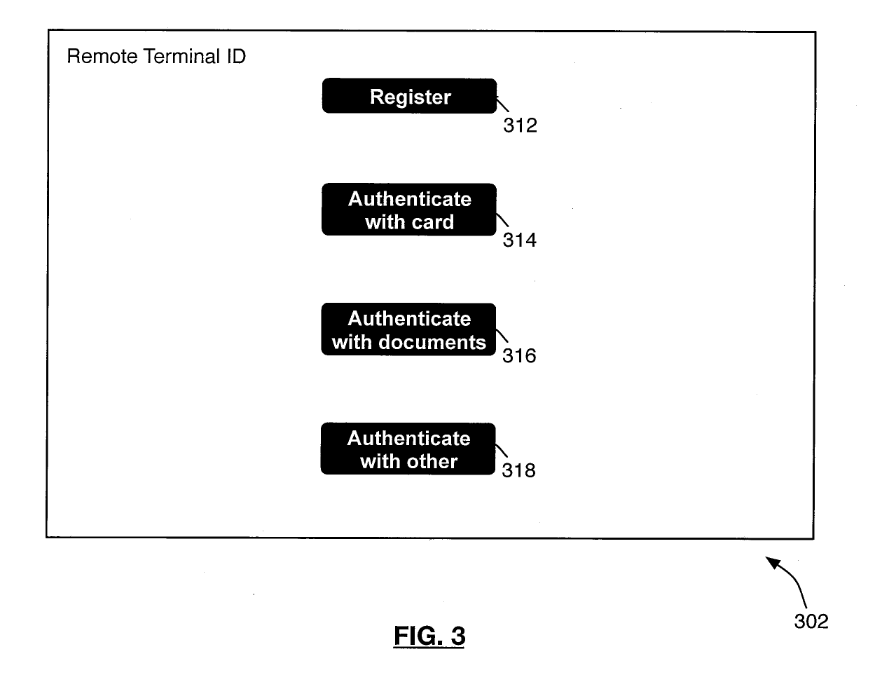

Referring now to FIG. 3, there is shown an exemplary default display for a remote terminal, in accordance with the embodiment of FIG. 2. Screen layout 302 can be presented on display 242 of remote terminal 240 and offers options to the customer for authenticating.

In the case of a new customer, the customer may select option 312 to initiate a registration process.

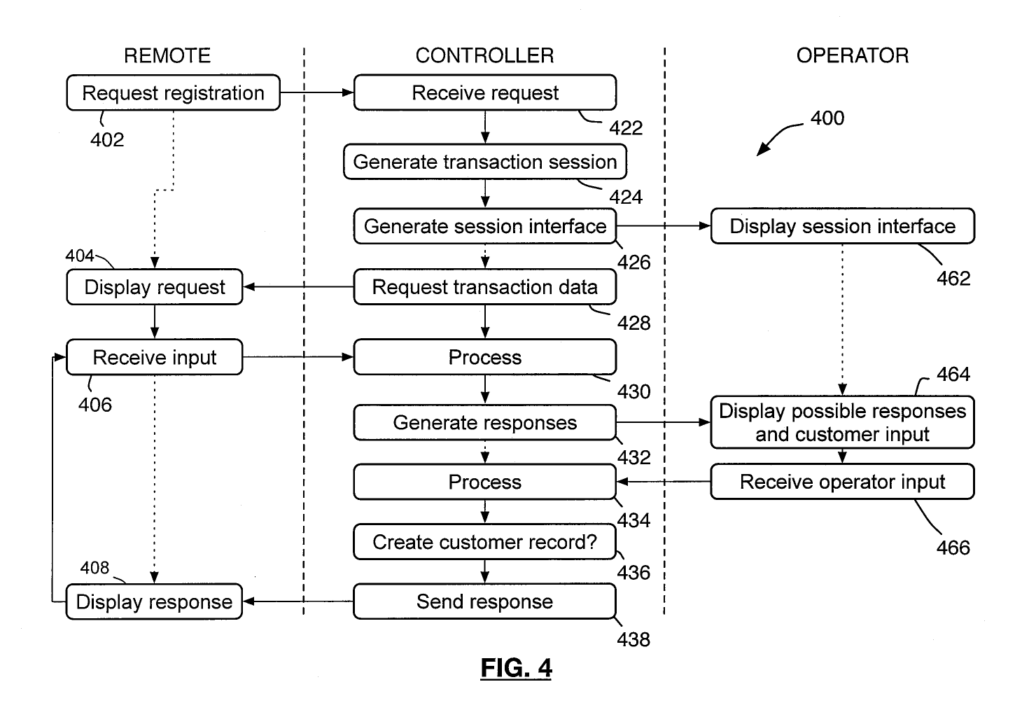

Referring now to FIG. 4, there is shown a flowchart diagram of an exemplary registration process.

At 404, the customer requests to register an account. Remote terminal 240 transmits the request to controller 220, which receives the request at 422. At 424, a session module at controller 220 generates a registration session and an interface module proceeds to generate a registration session interface at 426. Thereafter, a data processing module is operable to receive and transmit data between the remote and operator terminal. Controller 220 transmits a notification to operator terminal 210, whereupon operator terminal 210 displays the corresponding registration session interface at 462.

At 428, the data processing module at controller 220 requests registration data, which may include customer name, address, telephone number, social security number, driver's license number and the like. Registration data may further include demographic information, such as marital status, income and the like. Controller 220 may also request one or more forms of identification, such as government issued photo identification (e.g., driver's license, passport), a utility statement, and the like.

In some embodiments, the customer may be provided the option of registering an unaffiliated card of their choice to be used for future authentication purposes. For example, the unaffiliated card may be a credit card issued by another entity. Accordingly, the customer may swipe the unaffiliated card at a card reader of the remote terminal and data read from the magnetic strip of the card may be used to authenticate the customer during future sessions.

At 404, the request for registration data can be displayed to the customer and at 406, the customer may enter the requested registration data using a suitable combination of input 244 and document capture device 246. In some embodiments, image capture device 248 may also be used for input. Upon capture of the registration data, the entered registration data can be transmitted to controller 220 at 406.

The data processing module at controller 220 may format the received registration data or filter the registration data. In some embodiments, the data processing module at controller 220 may perform an initial analysis of the received data to determine if sufficient data has been provided. For example, if the customer has not provided an address, the module may determine that the registration data is deficient. In some embodiments, controller 220 may transmit an additional request to remote terminal 240 for the customer to provide the missing data.

Depending on the received data, the data processing module at controller 220 may generate and transmit, at 432, one or more possible response options for presentation to the human operator of operator terminal 210 in the corresponding session interface. The received and, optionally, processed registration data can also be transmitted for display in the corresponding session interface. The possible response options may be context specific. For example, if the customer has not provided income information in the registration data, the possible response options may include: 1) an option to accept the registration; 2) an option to re-request the missing data; 3) an option to request alternate data; and 4) an option to refuse the registration.

Each of the possible response options may be predetermined and standardized to be appropriate for the current context. Accordingly, in some embodiments the operator may not be permitted to communicate with the customer in free form text. By enforcing standardized responses, the customer experience can be consistent and the need for operator training can be reduced. Likewise, the potential for errors, fraud and time inefficiencies can be reduced.

At 464, operator terminal 210 displays the registration data and the possible response options generated by controller 220. The human operator 210 can see the registration data and possible response options. Additionally, throughout the registration session, image capture device 248 may capture one or more images of the customer. The images can be transmitted via controller 220 to operator terminal 210 for display in the session interface associated with the current registration session. Accordingly, the human operator using operator terminal 210 can correlate the captured images with the registration data, which may comprise photo identification, to determine if the customer is providing non-fraudulent identification documents. Likewise, the human operator may verify other non-photographic identification data, such as age or sex, by comparison with the captured images.

For example, the human operator at the processing center may decline to accept scanned documents for a number of reasons, such as: expired government ID, ID is not government issued, ID is not visible, utility bill type is not recognized, image captured by image capture device 248 does not match picture on scanned ID, ID presented does not have clear picture, or addresses on ID and utility bill do not match.

Operator terminal 210 may also provide a search interface for the human operator, described herein below in greater detail, which may be used to search customer database 232 to ensure that the customer does not already exist in the database and is therefore a new customer.

Accordingly, based on the data displayed in the session interface, the human operator can form a conclusion as to which response option to choose. In an exemplary embodiment, each human operator can be provided with a set of procedures for dealing with a wide variety of scenarios. The procedures may be updated on an as-needed basis.

At 466, operator terminal 210 receives input from the human operator indicating which response option was chosen and transmits the selected response option to controller 220. Based on the selected response option, the data processing module at controller 220 processes the response data at 434 and, if the response option indicates that the registration is accepted, controller 220 creates a new customer account in customer database 232, at 436.

At 438, the data processing module at controller 220 transmits the result of the response option to the remote terminal for display to the customer. For example, if the response option indicated that the registration request was accepted, the remote terminal may display a “successful registration” message. Additional registration details, such as an account number, may also be displayed. Alternatively, if the response option indicated that the registration was not accepted, the remote terminal may display an “unsuccessful registration” message, along with an indication of the reason for the unsuccessful registration.

If the customer is a returning customer, the customer may have already performed registration previously and may thus select their preferred means of authentication. Referring again to FIG. 3, the customer may select option 314 to authenticate with a card, such as an unaffiliated card selected during registration.

Alternatively, returning customers may choose to authenticate with a document by choosing option 316 or with personally identifying information by choosing option 318.

If the customer opts to authenticate with a card, document capture device 246 may be used to verify the card data according to the type of card, and remote terminal 240 can transmit the card data to operator terminal 210. For example, if the card is a magnetic strip card, document capture device 246 can read the magnetic strip data and transmit at least a portion of the captured data.

The card may be a prepaid credit card previously issued to the customer, or some other financial card that the customer has previously provided and permitted to be stored for future authentication. In some embodiments, not all captured card data is necessary to verify the card. For example, card data that is encrypted may be transmitted in unencrypted form, or the encrypted portions may be stripped out prior to transmission.

In particular, in some embodiments, only information that is not sensitive according to the Payment Card Industry (PCI) Data Security Standard may be used. Specifically, a partial account number, the customer name, the expiry date, and the service code. This information is non-encrypted. Accordingly, in some embodiments the system may be operated without a decryption key.

In some embodiments, the system may also be configured to enable a customer to initiate authentication by providing a date of birth and postal code. Controller 220 may search customer database 232 for customer records matching the date of birth and postal code and generate response options comprising all matching records, along with photos stored in the matching records. Accordingly, operator terminal 210 may display the response options and one or more current images captured by image capture device 248 to identify any matches.

The operator may examine the response options representing the closest matches and accept or reject the authentication attempt based on whether the individual at the remote terminal resembles the customer in the corresponding customer record. In some embodiments, the operator may request responses to additional security questions.

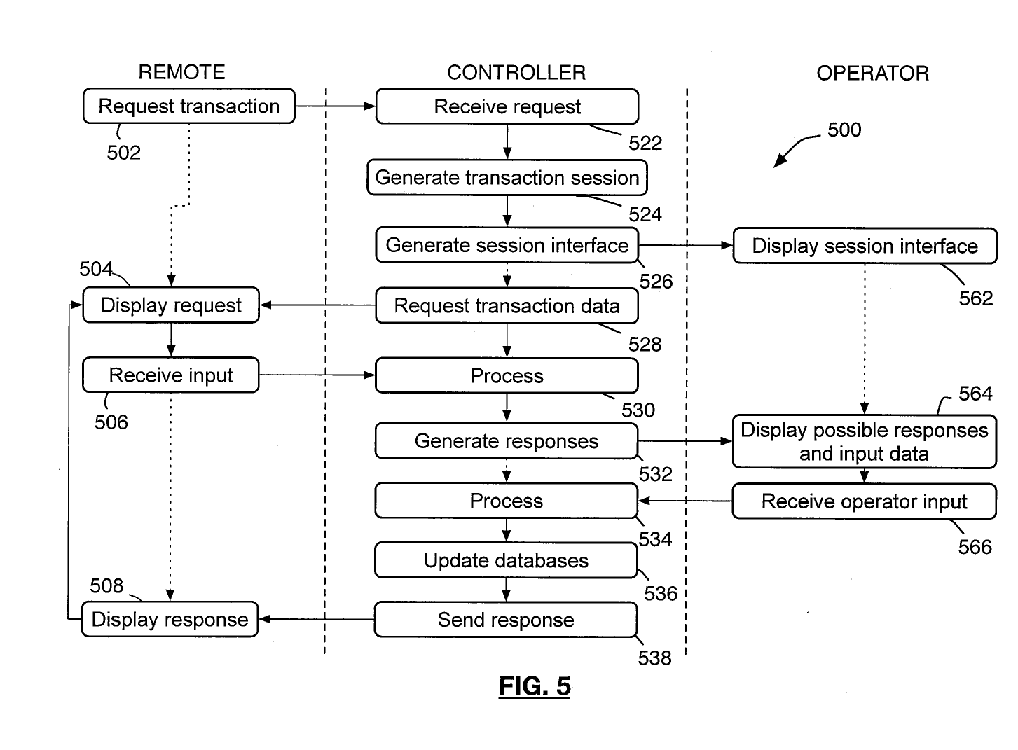

Referring now to FIG. 5, there is shown a flowchart diagram of an exemplary transaction method.

At 502, the customer requests to initiate a transaction session by authenticating with controller 220. The request may be communicated, for example by selecting option 314, 316 or 318. Regardless of the selected option, remote terminal 240 transmits the request to controller 220, which receives the request at 522. At 524, a session module at controller 220 generates a transaction session and an interface module proceeds to generate a transaction session interface at 526. Thereafter, a data processing module can receive and transmit data between the remote and operator terminal. Controller 220 transmits a notification to operator terminal 210, whereupon operator terminal 210 displays the corresponding registration session interface at 562.

At 528, the data processing module at controller 220 requests transaction data from remote terminal 240. If the transaction is new and the customer has not yet been authenticated, the requested transaction data may be authentication data. The requested authentication data may be based on the selected authentication option. For example, if the customer selected option 314, the requested authentication data may be a card associated with the customer's account.

Controller 220 may also request one or more forms of identification, such as government issued photo identification (e.g., driver's license, passport), a utility statement, and the like. If the selected authentication option is document based, then photo identification may be required.

If the transaction is already established, the transaction data request may be for transaction related information, such as the type of financial service request (e.g., cash check), amount verification and the like.

At 504, remote terminal 240 receives the transaction data request and displays it to the customer using the display 242. At 506, remote terminal 240 receives data from the customer relating to the transaction request, which can be entered by the customer using a suitable combination of input 244 and document capture device 246, and transmits the data to controller 220.

At 530, the data processing module at controller 220 receives the transmitted data and may process the data. For example, the data processing module at controller 220 may format the received transaction data or filter the transaction data. In some embodiments, the data processing module at controller 220 may perform an initial analysis of the received data to determine if sufficient data has been provided. For example, if the customer has not provided a required piece of data, such as photo identification, controller 220 may determine that the transaction data is deficient. In some embodiments, controller 220 may transmit an additional request to remote terminal 240 for the customer to provide the missing data.

In some embodiments, remote terminal 240 may be configured to provide an interface to the customer in a first, customer language whereas the operator terminal 210 may be configured to provide an interface to the operator in a second, operator language that differs from the customer language. In such cases, controller 220 may be configured to translate data and requests, if necessary, and to provide notifications to each terminal in the appropriate language. In some embodiments, controller 220 may be configured to receive and transmit language-agnostic data and each terminal may be configured to localize the data into the desired language. Accordingly, in some embodiments, this translation may be opaque to the customer, such that the customer may not be aware that the remote terminal is in communication with an operator terminal and a human operator.

Depending on the received data, the data processing module at controller 220 may generate and transmit, at 532, one or more possible response options for presentation to the human operator of operator terminal 210 in the corresponding session interface. The received and, optionally, processed transaction data can be transmitted for display in the corresponding session interface. The possible response options may be context specific.

For example, if the transaction request is for document based authentication, the possible response options may include: 1) an option to authenticate the customer; 2) an option to re-request the photo identification, due to inability to read the photo identification image (e.g., due to defacement) data; 3) an option to request alternate data; and 4) an option to refuse authentication.

In another example, if the transaction request is for a check cashing operation and the transaction data includes an image of a check, the possible response options may include: 1) an option to cash the check; 2) an option to refuse the check due to defacement; and 3) an option to refuse the check due to a large amount; 4) an option to refuse the check due to it lacking an endorsement; 5) an option to refuse the check due to it being incorrectly dated; 6) an option to refuse the check due to it being made out to the incorrect individual; and other reasons that may be appropriate in the context of the check cashing operation.

At 564, operator terminal 210 displays the transaction data and the possible response options generated by controller 220. The human operator 210 can see the transaction data and possible response options. Additionally, throughout the transaction session, image capture device 248 may capture one or more images of the customer. The images can be transmitted via controller 220 to operator terminal 210 for display in the session interface associated with the current transaction session. Accordingly, the human operator using operator terminal 210 can correlate the captured images with the transaction data, which may comprise photo identification, to determine if the customer is providing non-fraudulent identification documents. Likewise, the human operator may verify other non-photographic identification data, such as age or sex, by comparison with the captured images.

Accordingly, based on the data displayed in the session interface, the human operator can form a conclusion as to which response option to choose. For example, if the operator is satisfied that the captured images match the information contained in the scanned or stored government identification documents, the operator may select an “accept” option. Alternatively, the operator may select one or more “decline” options the documents and send back an error message to the kiosk user by clicking on any of the error or decline messages available to the operator, which are predetermined and are specific to that stage of processing which required action or acceptance by the human operator at the processing center.

If the transaction is at the authentication stage, the operator terminal receives images of the customer documents as opposed to data transcribed by the customer. Accordingly, security can be increased and fraud and identity theft risks reduced. Customer convenience can also be enhanced because there is no need for difficult or lengthy data entry.

In an exemplary embodiment, each human operator is provided with a set of procedures for dealing with a wide variety of scenarios. The procedures may be updated on an as-needed basis.

At 566, operator terminal 210 receives input from the human operator indicating which response option was chosen and transmits the selected response option to controller 220. Based on the selected response option, the data processing module at controller 220 processes the response data at 534 and, if the response option indicates that the transaction is accepted, controller 220 updates the corresponding customer account record in customer database 232 and the corresponding transaction history in transaction database 234, at 536.

At 538, the data processing module at controller 220 transmits the result of the response option to the remote terminal for display to the customer. At 508, remote terminal 240 displays the result of the response option. For example, if the response option indicated that the transaction request was accepted, the remote terminal may display a “successful transaction” message. Additional transaction details, such as an account number, may also be displayed.

In some cases, the result of the response option may indicate that further data is required. If further data is required, remote terminal may return to 504 to display an indication of the required data and receive the required data at 506. Accordingly, controller 220 may repeat 530-538 and operator terminal 210 may repeat 564-566.

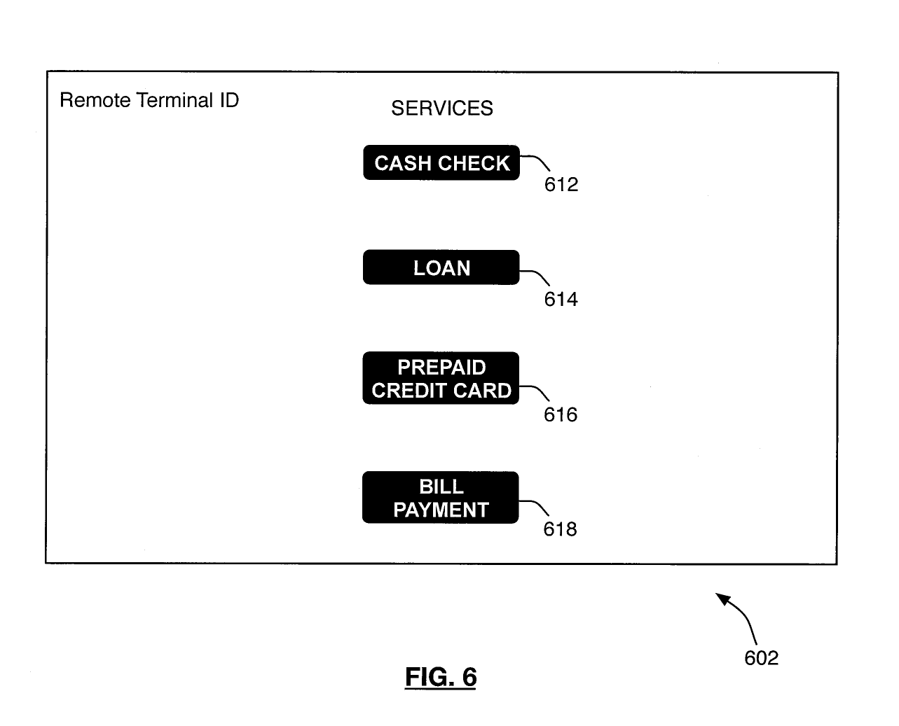

For example, if the result of the response option indicates that authentication was successful, the customer may next select the type of transaction to be conducted. The type of transaction may be selected from the services menu, an example of which is described herein below with reference to FIG. 6.

In another example, if the response option indicated that authentication was not successful because a scanned document was unreadable, the remote terminal may display a “rescan document” message.

Referring again to FIG. 3, there is shown an example authentication screen that may be displayed to a customer at remote terminal 240.

Authentication screen 302 has a plurality of options displayed, including register option 312, card authentication option 314, document authentication 316 and other authentication option 318. If authentication screen 302 is displayed on a touchscreen of remote terminal 240, each option may serve as a selectable button. Alternatively, each option may be displayed adjacent a soft button of input 244, or may be displayed as an alphanumeric reference in close proximity to the option, for the user to select from a keypad or keyboard of input 244.

Referring now to FIG. 6, there is shown an example service screen that may be displayed to a customer at remote terminal 240.

Service screen 602 has a plurality of options displayed, including cash check option 612, loan request option 614, prepaid credit card option 616 and bill payment option 618. In some embodiments, there may be more or fewer options displayed, depending on the available service offerings. In particular, the available services may be tailored according to the customer record in customer database 232, transaction history in transaction database 234, and other business factors. For example, if a customer has an outstanding loan, loan request option 614 may not be displayed.

Options may include alternative financial services, such as check cashing, bill payments, automated banking services (e.g., cash withdrawal), dispensing prepaid financial cards, loading money onto prepaid financial cards, obtaining short-term “payday” loans, and repaying loans. In some embodiments, options may also include foreign currency exchange, money orders, and money transfers.

If service screen 602 is displayed on a touchscreen of remote terminal 240, each option may serve as a selectable button. Alternatively, each option may be displayed adjacent a soft button of input 244, or may be displayed as an alphanumeric reference in close proximity to the option, for the user to select from a keypad or keyboard of input 244.

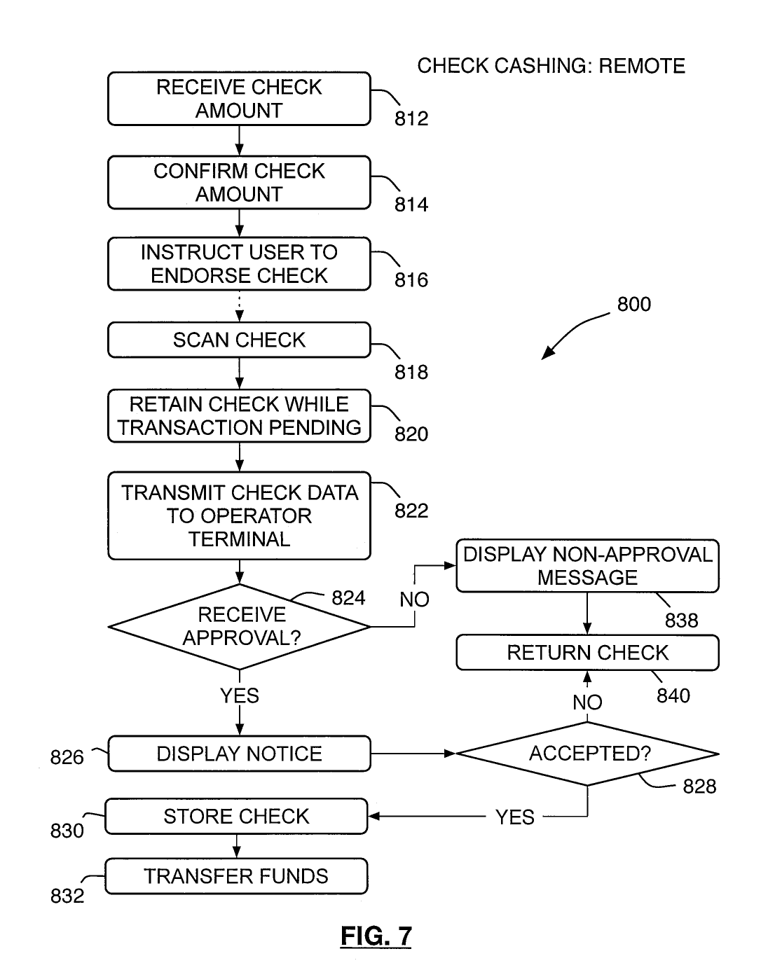

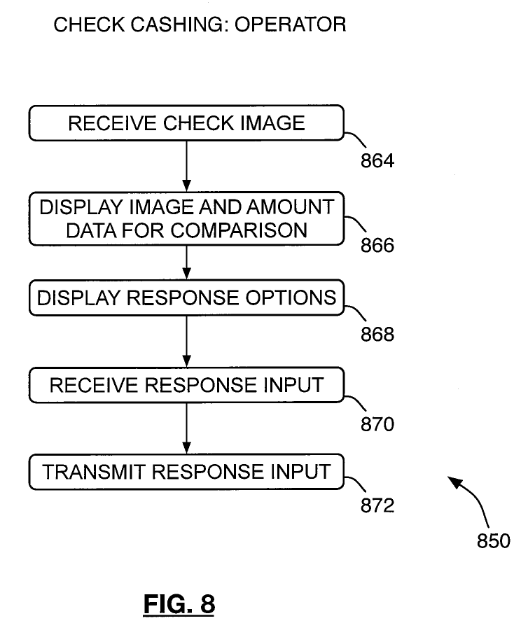

Referring now to FIGS. 7 and 8, there are shown process flow diagrams for carrying out a transaction session between an operator terminal and remote terminal. FIG. 7 illustrates the process steps performed at a remote terminal, such as remote terminal 240. FIG. 8 illustrates the process steps performed at an operator terminal, such as operator terminal 210.

For the purposes of illustration, the sample process flow diagrams shown in FIGS. 7 and 8 describe a check cashing transaction. However, it will be understood that the principles described are applicable to other transactions that may be processed by the embodiments described herein.

Remote terminal process 800 begins once a check cashing transaction has been selected. At 812, remote terminal 240 receives a check amount entered by the customer using a suitable input method, such as input 244. For example, the check amount may be entered using a keypad or touchscreen. Optionally, at 814, the customer may be prompted to confirm the check amount by selecting an appropriate option, in which case the customer may also change the check amount.

In some embodiments, the customer may be prompted to endorse the check at 816 and place the check to be cashed in or on document capture device 246.

Document capture device 246 is operable to scan the check at 818 to generate images of the front and back sides of the check. In some embodiments, the customer may be prompted to flip the check so that an opposite side of the check can be imaged. In other embodiments, document capture device 246 may comprise a commercially available MICR check scanner, such as the EC 7011 check scanner produced by RDM Corporation of Waterloo, Canada, which generates images of the front and back of the check and reads the MICR data on the check.

In an exemplary embodiment, document capture device 246 retains the check at 820 until the transaction is completed.

Once the check has been scanned and MICR data read, the transaction data, comprising the scanned information and the check amount entered by the customer, can be transmitted to operator terminal 210 at 822.

At 824, remote terminal 240 receives an indication from operator terminal 210 whether the check transaction was approved or rejected.

If the transaction was approved, an indication can be displayed at 826 notifying the customer of approval. In some embodiments, the notification may indicate the amount of a transaction fee to be applied. The transaction fee, if accepted by the customer, can be deducted from the funds to be dispensed or transferred.

The check amount, which was previously stored locally, may be transmitted to a currency dispenser at the remote terminal for dispensing to the customer.

At 828, the customer indicates whether the transaction fee is accepted. In some embodiments, the customer may elect to apply the remaining funds to a banking account via a debit card, or to apply the funds to a prepaid card.

If the transaction fee is accepted, the check may be deposited in a check storage unit of remote terminal 240, at 830. At 832, the funds are dispensed or transferred according to the option elected by the customer.

Alternatively, if the transaction fee is refused at 828, the check may be returned to the customer at 840. Likewise, if the transaction was rejected at 824, remote terminal 240 may display a rejection notification at 838 and return the check at 840. The rejection notification may comprise an explanation of why the check was refused. In some embodiments, the rejection notification may comprise instructions for the customer to provide further information, to re-scan the check, or the like.

In some embodiments, checks stored in the check storage unit of remote terminal 240 may be physically retrieved by authorized personnel and deposited at a bank branch for processing. In other embodiments, checks stored in the check storage unit of remote terminal 240 may be electronically processed and cleared using Automated Clearing House (ACH).

Referring now to FIG. 8, there is shown a process flow diagram for an exemplary operator terminal, corresponding to the process flow diagram for the exemplary remote terminal of FIG. 7.

At 864, the operator terminal receives transaction data from the remote terminal. In a check cashing transaction in an exemplary embodiment, the transaction data comprises images of the front and back side of the check, along with MICR data, the check amount entered by the customer and related data.

At 866, the operator terminal displays the check images on a display, along with the entered check amount. Accordingly, a human operator can compare the check images with the amount entered by the customer to verify if the amount written on the check matches the amount entered at the remote terminal.

At 868, the operator terminal displays response options for the human operator. The response options may be selected based on the current transaction. For example, in a check cashing transaction, the response options may include: accepting the transaction, rejecting the transaction because the check is not readable, rejecting the transaction because MICR data is incorrect or missing, rejecting the transaction because the customer has exceeded a credit limit, and the like.

At 870, the operator terminal receives input from the human operator indicating which of the response options was selected. Accordingly, the human operator may choose to accept the check at 870 by selecting an accept option if verification criteria are satisfied. Verification criteria may include: 1) the amount on the check matches the user entered amount, 2) the check is made out to the correct individual, 3) the check does not display visible signs of tampering, and the like.

Alternatively, the operator can select rejection options at 870 as appropriate. Accordingly, the requirement for data entry by the human operator can be minimized, which may increase efficiency and minimize data entry error.

In some embodiments, the decision to accept or reject the check may not be based on software at all, but instead can be made solely by the human operator. A human operator can have superior decision-making capability as compared to rule-based software programs. That is, a human operator may be trained in risk management and banking procedures in order to successfully determine whether to accept or reject checks based on personal knowledge of credit, lending, and risk. Customer history may also be considered.

Accordingly, by relying on human operators to form decisions, fraud may be reduced while retaining considerable flexibility to cash a wide variety of checks, such as personal, small business checks from unknown parties, and the like. In contrast, rule-based software systems often limit the types of checks that are cashable to commonly known, highly creditworthy payers, such as governments and large corporations. Such systems may employ optical character recognition to recognize the type of check and make an automatic cashing decision. Accordingly, automated check cashing services are limited when compared to retail check cashing establishments, which employ humans to make check cashing decisions.

However, in some embodiments, the decision to accept or reject the check may be assisted by software. In such embodiments, the software may perform an initial analysis and present its decision to the human operator for confirmation.

In the context of other transactions, if the customer requests a short-term loan, the customer may be requested to provide information that may be used by the human operator to assess credit worthiness. For example, the customer may be requested to scan a recent pay stub as well as a recent bank statement using the general purpose document scanner. Images of the scanned documents may be transmitted to the operator terminal for display to the operator. Customers may be accustomed to providing these documents, as these documents are typically required in a retail, “bricks and mortar” loan provider. Accordingly, the customer may feel more comfortable and familiar utilizing the system described herein.

Upon receiving the document images, the operator may analyze the documents for completion and accuracy. Specifically, the operator may ensure that the bank statement is for the correct customer, that the bank account is in use on a regular basis, that the customer's recent pay checks have been deposited into the bank account, and that the pay stub is recent and indicates regular full time employment. If the operator is satisfied with the documents, he or she may calculate a proposed loan amount, which is transmitted to the remote terminal. The proposed amount may be, at least in part, based on established guidelines for the operator, and may provide a ratio of loan to weekly or biweekly income. The operator terminal may provide a calculator interface to assist the human operator, in which the operator may input customer pay information to determine the appropriate amount. Accordingly, the calculator may automatically calculate the maximum loan amount based on a policy for loan to income ratio. In some embodiments, the calculator may also take into account the transaction history of the customer.

If the operator decides to reject the loan request, the operator may select a rejection option provided by the operator terminal, and a corresponding error message can be transmitted to the remote terminal for display to the customer. Depending on the rejection reason, the customer may then be prompted to either correct a problem, or the transaction may be cancelled altogether.

If the operator decides to accept the loan request, the operator may select an accept option provided by the operator terminal. Accordingly, the operator may also enter a loan amount that is authorized, or may simply accept the calculated loan amount. A corresponding indication of the approved loan amount can be transmitted to the remote terminal for display to the customer. The customer may accept the maximum authorized loan amount, or may reduce the loan amount to a lower desired amount.

Upon selecting the loan amount, the customer may be prompted to write a check in the amount of the loan plus interest. The interest amount may be computed by the remote terminal, controller or operator terminal, in accordance with rates established in a policy. Subsequently, the customer can be instructed to scan the check in a check scanner. The check scanner can scan the front and back of the check and reads MICR data. The scanned data can be transmitted to the operator terminal, along with the selected loan amount.

Upon receiving the scanned data and loan amount, the operator may verify that the customer has written the check for the appropriate amount, has signed the check, and that the check MICR matches the bank information from the previously scanned bank statement. If the operator accepts the check images, a notification can be transmitted to the remote terminal and the customer can be instructed to deposit the check in the remote terminal. If the operator rejects the images or MICR data, the operator may select an error message from the operator touch screen menu provided, and such error may be transmitted to the remote terminal. Depending on the rejection reason, the customer may be prompted to either correct the problem, or the transaction may be cancelled altogether.

If the transaction is approved, the customer may have the option of selecting a form of payment.

For example, the customer may have the option of receiving the loan amount in cash, in funds transferred to a prepaid card, or some combination thereof. If the customer selects cash, a currency dispenser may dispense the appropriate amount of currency. If the customer selects the prepaid card option, and the customer has an existing prepaid card, the customer account corresponding to the prepaid card may be simply updated to reflect the loan amount.

If customer user does not have an existing prepaid card, the remote terminal may be configured to dispense a new card to the customer. The remote terminal may prompt the customer to confirm whether a new card is desired. Accordingly, the customer account corresponding to the new prepaid card may be updated to reflect the loan amount.

Prepaid cards dispensed at the remote terminal may be non-personalized, temporary prepaid credit cards. Accordingly, after dispensing the temporary prepaid card, controller 220 may communicate customer details to a prepaid card issuer, which may then issue a personalized prepaid card to the customer.

Upon authentication, it may be determined that the customer has an outstanding loan. Accordingly, one of the service options presented may be an option to repay the outstanding loan.

Following display of the outstanding loan amount, the customer may be presented the option of repaying all or part of the loan using the funds source of their choice. For example, cash or debit or credit card.

If the customer elects to provide cash repayment, the remote terminal may display a notice to feed currency to the currency acceptor, which may accept coins and bills until the customer chooses a “payment complete” option, indicating that the desired amount has been deposited. If the customer elects to provide funds by debit or credit, the customer may be prompted to enter a desired repayment amount and processed accordingly.

Other financial transactions, such as loading a prepaid card, will become apparent. The described embodiments facilitate the delivery of a wide variety of financial services, including, but not limited to, check cashing, payday loans, bill payments, prepaid card solutions, money orders, money transfers, and foreign exchange. By providing these services via a flexible platform, and in a way that is familiar and intuitive to the customer, cost effectiveness and convenience to the customer and operator can be enhanced.

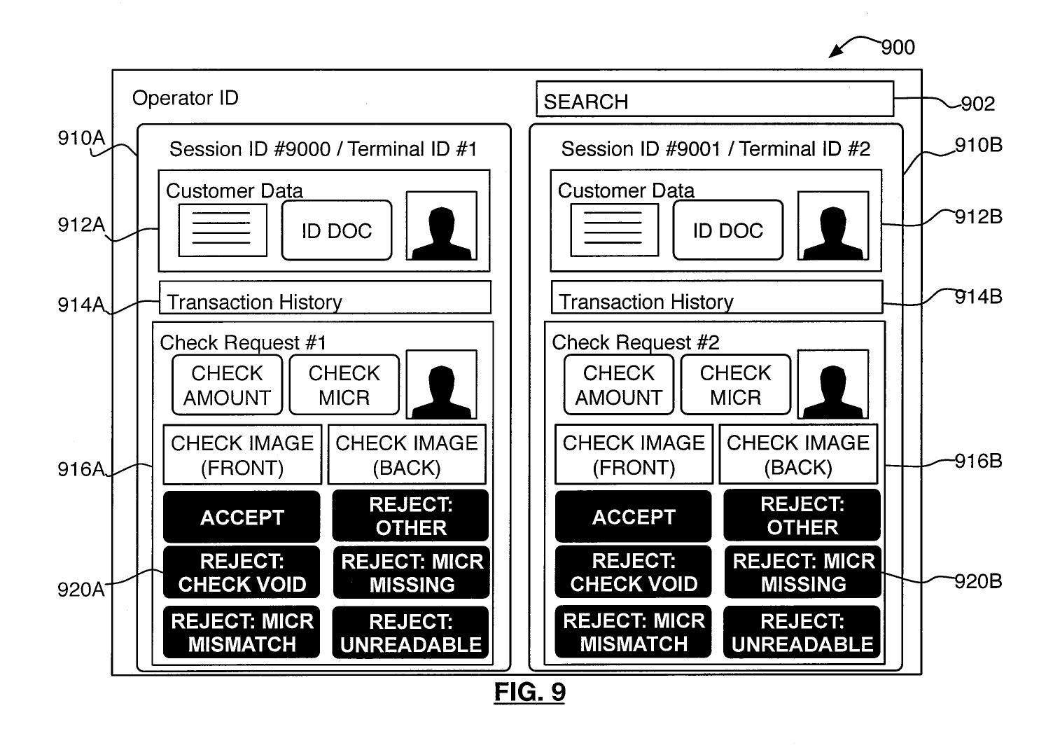

Referring now to FIG. 9, there is shown an exemplary operator display.

Operator display 900 is operable to substantially concurrently display two operator session interfaces 910A and 910B. Each operator session interface is dedicated to a particular transaction session. For example, operator session interface 910A is dedicated to a transaction session uniquely identified by the number 9000 with a remote terminal uniquely identified by the number 1. Conversely, operator session interface 910B is dedicated to a transaction session uniquely identified by the number 9001 with a remote terminal uniquely identified by the number 2. The number of displayed operator session interfaces may be between one and a predetermined maximum concurrent number of transaction sessions. The maximum concurrent number of transaction sessions may be determined based on the number of active transaction sessions, the number of available operator terminals, the available display space on the operator display and other factors that may be determined empirically or otherwise.

In some embodiments, the unique transaction session identifier may be a unique customer identifier, such as, for example, a combination of the customer's name and a unique number.

In some embodiments, each operator session interface has a one-to-one mapping with a corresponding remote terminal, such that each transaction session involves only one operator terminal and only one remote terminal.

Each operator session interface 910 is operable to display session data associated with the current transaction, which may comprise a customer data portion 912, a transaction history portion 914 and a current transaction portion 916.

Customer data portion 912 can display previously known customer data that may be stored in a customer database. For example, customer data portion 912A can display biographical data, such as address and telephone number of the customer, an image of one or more identification documents, and an image of the customer's face. The displayed customer data may be used by a human operator for comparison with current images from the remote terminal image capture device, with check data, and with other data that may be displayed in current transaction portion 916.

Transaction history portion 914 can display previous and recent transactions performed by the customer currently using the remote terminal associated with the transaction session. For example, transaction history 914A can display previous and recent transactions performed by the customer displayed in customer data portion 912A and currently authenticated as using remote terminal with ID #1.

Current transaction portion 916 can display transaction data for the operator to review and act upon. For example, customer transaction portion 916A can display check amount data, check MICR data, a current image from the remote terminal image capture device, images of the check and a plurality of response options 920A.

The operator display may be provided on a touchscreen device, in which case response options 920A and 920B may be virtual buttons. Each operator display 212 can comprise a touchscreen and two viewing monitors. The touch screen may be configured to allow a human operator to accept information received from a remote terminal, select among error messages for transmission to the remote terminal, search customer or transaction databases, and view customer profiles, previously scanned documents or transaction histories.

Operator display 900 may further comprise a search interface 902, which may be used to perform searches of customer and other databases.

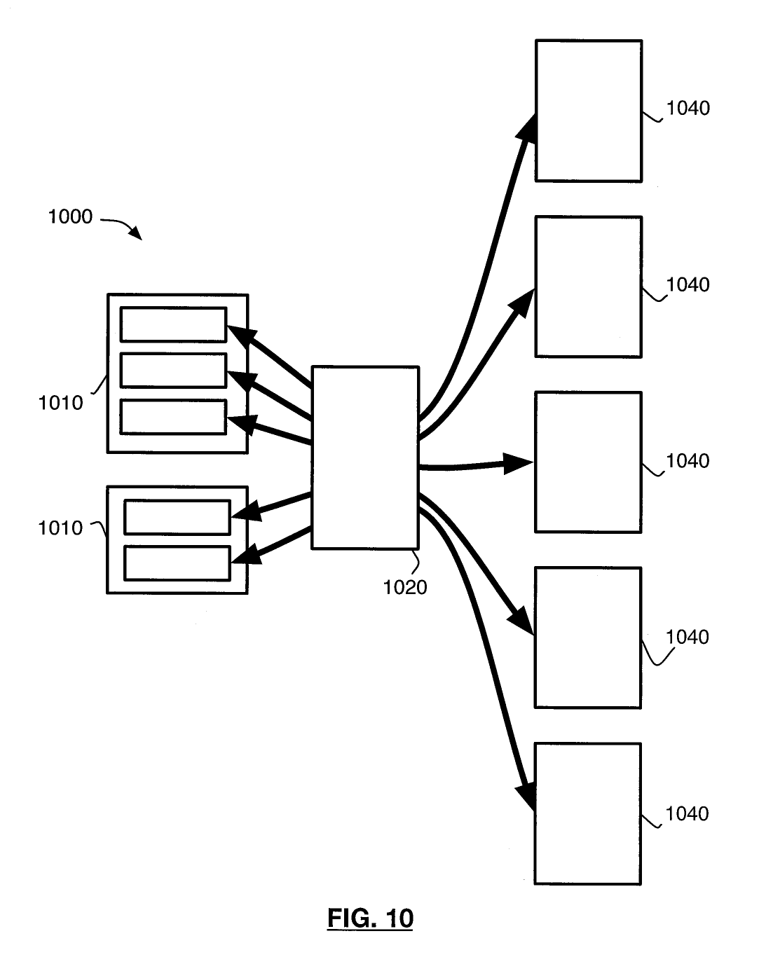

Referring now to FIG. 10, there is shown an exemplary embodiment in which two operator terminals 1010 are connected to five remote terminals 1040 by controller 1020. Accordingly, controller 1020 may be operable to load balance requests from a plurality of remote terminals among a number of available operator terminals. Load balancing may be based on a number of factors, such as a number of concurrently and previously established transaction sessions at each operator terminal. Another factor that may be considered is the customer's desired language and the human operator's language abilities. That is, controller 1020 may attempt to establish transaction sessions to ensure that the human operator can communicate with the customer in the customer's desired language, particularly if controller 1020 is not configured to translate languages.

It will be appreciated that various embodiments may comprise one or more special purpose or general purpose computers or servers, each of which may include, but are not limited to, one or more processors, memories, storage devices, input/output devices and network interfaces. Likewise, the terms ‘computer’ and ‘server’ may be interchangeable in accordance with the above description. Although embodiments have been described as separate components, it will be understood that various components could be combined into a single computer or server, or implemented across multiple computers or servers all connected via a communications medium such as the Internet. Likewise, it will be understood that functionality described herein as being provided by a specific component or module may also be provided by another component or module without departing from the scope of these embodiments. For example, some functionality of controller 220 may be delegated to operator terminal 210 or remote terminal 240.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for providing two-way communication, the system comprising:
at least one operator terminal comprising an operator display and an operator input device;
a plurality of remote terminals, wherein each of the plurality of remote terminals is connectable to the at least one operator terminal for communication therewith, and comprises a remote display and at least one remote input device operable to receive customer transaction data comprising at least one customer request from a customer;
a processor connectable to the at least one operator terminal and the plurality of remote terminals for communication therewith;
a non-transitory computer-readable storage medium with an executable program stored thereon, the program for instructing the processor to provide:
a session module for establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal;
a data processing module operable to receive, for each transaction session, the customer transaction data relating to the transaction session from the corresponding remote terminal, and generate, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and
an interface module operable to, at the specific time, provide a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.

2. The system of claim 1, wherein for each transaction session and the corresponding operator session interface, the data processing module is further operable to receive operator input data from the operator input device identifying one of the plurality of possible request responses.

3. The system of claim 2, wherein for each transaction session the data processing module is further operable to generate response data based on the operator input data and transmit the response data to the corresponding remote terminal.

4. The system of claim 1, wherein the session module is operable to establish each transaction session in the maximum concurrent number of transaction sessions upon receiving a corresponding session initiation request from the corresponding remote terminal.

5. The system of claim 1, wherein for each transaction session the session module is further operable to generate a unique identifier for distinguishing that transaction session from all other transaction sessions in the maximum concurrent number of transaction sessions.

6. The system of claim 1, wherein for each transaction session in the maximum concurrent number of transaction sessions, the processor is further operable to generate a unique customer identifier based on the customer transaction data, the unique customer identifier corresponding to the customer using the corresponding remote terminal, generate a customer record corresponding to the unique customer identifier, and store the customer record in a transaction database.

7. The system of claim 1, wherein for each transaction session in the maximum concurrent number of transaction sessions, the processor is further operable to determine a unique customer identifier based on the customer transaction data, the unique customer identifier corresponding to the customer using the corresponding remote terminal, and update a customer record corresponding to the unique customer identifier and stored in a transaction database, the update based on the transaction session.

8. The system of claim 7, wherein for each transaction session in the maximum concurrent number of transaction sessions, the processor is further operable to retrieve, based on the unique customer identifier, the customer record stored in the transaction database and configure the corresponding operator session interface to display information based on the customer record.

9. The system of claim 1, wherein the at least one operator terminal comprises two or more operator terminals, and wherein the session module establishes, at the specific time, up to the maximum concurrent number of transaction sessions with the two or more operator terminals, such that each transaction session involves one and only one corresponding remote terminal and one and only one of the two or more operator terminals.

10. The system of claim 9, wherein the session manager is operable to load balance between the two or more operator terminals when establishing transaction sessions, such that the session manager is operable to establish each transaction session in the maximum concurrent number of transaction sessions based on, for each operator terminal, a number of currently and previously established transaction sessions at that operator terminal.

11. The system of claim 1, wherein for each transaction session in the maximum concurrent number of transaction sessions, the corresponding remote terminal is configurable to interact with the customer in a customer language, and the processor is operable to translate the customer transaction data that is received in the customer language for presentation in the corresponding operator session interface in an operator language that differs from the customer language.

12. The system of claim 1, wherein each of the plurality of remote terminals comprises a document imaging device for capturing at least one document image, and wherein the customer transaction data for each remote terminal comprises the at least one document image.

13. The system of claim 1, wherein each of the plurality of remote terminals comprises a customer imaging device for capturing at least one image of the customer, and wherein the customer transaction data for each remote terminal comprises the at least one image.

14. A method for providing two-way communication, the method comprising:
connecting at least one operator terminal to a plurality of remote terminals for communication therewith, wherein the at least one operator terminal comprises an operator display and an operator input device, and wherein each of the plurality of remote terminals comprises a remote display and at least one remote input device operable to receive customer transaction data comprising at least one customer request from a customer;
establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal;
receiving, for each transaction session, the customer transaction data relating to the transaction session from the corresponding remote terminal, and generating, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and
providing, at the specific time, a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.

15. A computer program product for use on a computer, the computer program product comprising:
a non-transitory recording medium; and
means recorded on the non-transitory recording medium for instructing the computer to perform the steps of:
connecting at least one operator terminal to a plurality of remote terminals for communication therewith, wherein the at least one operator terminal comprises an operator display and an operator input device, and wherein each of the plurality of remote terminals comprises a remote display and at least one remote input device operable to receive customer transaction data comprising at least one customer request from a customer;
establishing, at a specific time, up to a maximum concurrent number of transaction sessions to enable a maximum concurrent number of remote terminals in the plurality of remote terminals to communicate with the at least one operator terminal at the specific time, wherein the maximum concurrent number is an integer greater than one, and there is a one-to-one mapping between the maximum concurrent number of transaction sessions and the maximum concurrent number of remote terminals such that each transaction session involves one and only one corresponding remote terminal;
receiving, for each transaction session, the customer transaction data relating to the transaction session from the corresponding remote terminal, and generating, using the processor, session data for the corresponding transaction session, wherein the session data for each transaction session is based at least on the customer transaction data received in the corresponding transaction session and comprises at least a plurality of possible request responses to the at least one customer request in the customer transaction data received in the corresponding transaction session; and
providing, at the specific time, a maximum concurrent number of operator session interfaces accessible by an operator at the at least one operator terminal, by generating, for each transaction session and corresponding remote terminal, a corresponding operator session interface at the at least one operator terminal such that each operator session interface in the maximum concurrent number of operator session interfaces is operable to display, at the specific time, the session data for the corresponding transaction session from the one and only one corresponding remote terminal in the maximum number of remote terminals, and by substantially contemporaneously displaying, on the operator display, the maximum concurrent number of operator session interfaces.
